(19) United States
(12) Patent Application Publication
(10) Pub. No.: US 2011/0110181 A1
(43) Pub. Date: May 12, 2011

(54) Method and apparatus for mixing and/or blending fluids

(76) Inventors: Peter Douglas Jack, Tsawwassen (CA); Nels Robert Ladouceur, Richmond (CA)

(21) Appl. No.: 12/386,935

(22) Filed: Apr. 23, 2009

(51) Int. Cl. B01F 3/04

(52) U.S. Cl. 366/151.1; 261/79.2; 261/62; 366/165.2

(57) ABSTRACT

A method and apparatus for mixing and/or blending fluids in a pressurized container, where fluids flow through an elongated blunt ended stinger and/or an inwardly chamfered ended stinger within the container, where under controlled pressure the fluids are substantially mixed or blended within the container. An optional diffuser plate adjacent the stinger end may be used.

### TECHNICAL FIELD

The invention relates to a method and apparatus for mixing and/or blending fluids and more specifically to a method and device that can generate finer micro sized bubbles to enhance floatation of entrained particles for separation of same, or generate an enhanced shearing dynamic for mixing and/or blending of fluids.

### BACKGROUND OF THE INVENTION

For many years air or gas bubbles have been used to separate particles in a fluid. This method has ranged in use from separation of petroleum derivatives, to separation of sludge from effluent. When separating these particles it has been found that the smaller the bubble, and hence the more numerous the bubbles, the longer the bubbles are suspended in a fluid and that these smaller and more numerous bubbles improve floatation of the particles, by more readily attaching to the particles. Then as the bubbles rise with the particles attached, the particles are then skimmed off.

As well, it has been found that the same device used to form these tiny bubbles can also be used to combine or blend fluids. It should be noted that for the purposes of the method and apparatus of the present invention, the term “fluid” or “fluids” may include a gas or a liquid and where a gas may include particles that flow with the gas, and a liquid may include more than one type of liquid. As well of course the liquid may include particles. Further, when blending, the “fluid” may be a dry powder that flows as a liquid. Only the apparatus scale or valve types may be required to change in the event of the mixing or blending of “fluids”. The apparatus and method of the present invention remain basically the same.

Accordingly, it is an object of the present invention to provide a method and apparatus that can produce extremely tiny bubbles.

Another object of the present invention is to provide a method and apparatus that can blend different fluids by using a method of dynamic shearing of one fluid into a second fluid.

The method and apparatus for mixing and/or blending fluids of the present invention has other objects and features of advantage which will become apparent from and are set forth in more detail in, the accompanying drawings and following details.

### DISCLOSURE OF THE INVENTION

The method and apparatus for mixing and/or blending fluids of the present invention is capable of functioning within many different applications. In general the process includes a pressurized container, where within the container there is an inlet where the inlet has a “stinger”. The stinger is preferably made of a slender cylindrical tube having a fixed internal diameter, where the tube extends into the container at least 2 percent and up to 80 percent of the length of the container, depending on the application. The container includes an outlet where the fluids exit. The outlet flow is generally controlled by a valve, where the valve leads to an external container. The external container is generally open to atmospheric pressure.

When producing micro bubbles for particle floatation the unit generally uses a blunt squared off stringer nozzle, which causes the fluids to dynamically commingle. In this case the fluids are generally air and water with the water containing particles for separation. The container includes an outlet where the fluids exit. It has been found that this configuration produces an extremely fine bubble which enhances the separation process. The outlet flow is also generally controlled by a valve, where the valve leads to an external container. The external container is open to atmospheric pressure and may include a mechanical skimmer to separate off the floating particles, usually as a scum or sludge.

The container may also include a bleeder valve, where the bleeder valve is positioned on the top of the container, so that in the event of air or gasses building up, the bleeder valve can bleed off this gaseous build up. This can be done manually or automatically with the use of a commonly available auto-bleed valve.

When blending fluids a different stinger shape may be chosen depending on the fluids to be mixed or blended.

It should be noted that up to three or even more fluids which may or may not be soluble, can be commingled, blended, mixed and/or dissolved in whole or in part into each other, for the purpose of separation of suspended solids by flotation, blending two or more fluids into a homogeneous mixture, aerating a fluid or multiple fluids to increase the total volume, or to provide for an efficient method of pressurized oxidation and/or disinfection of a pathogen laden material by use of a gas such as ozone.

It is a common practice to use a percentage of recycling of the fluids of about 25% of the total fluid being treated to enhance the separation and/or mixing process.

In another embodiment of the present invention, there is a secondary process/apparatus that includes the duplication of the first process/apparatus, where the outlet of the first container goes into the inlet of a second container, and where the second container includes an outlet where the fluids exit the mixing or blending apparatus. In this case the outlet of the first container goes directly into the second container and then into a stinger that enters directly after the inlet in the second container.

Also, an optional diffuser plate may be mounted adjacent the stinger end to aid in diffusing of certain types of fluids for mixing and/or blending as desired.

### BRIEF DESCRIPTION OF THE DRAWINGS

Advantages of the present invention will become more fully appreciated as the same becomes better understood when considered in conjunction with the following detailed description of an illustrative embodiment and accompanying drawings, in which like reference characters designate the same or similar parts throughout the several views, and wherein;

FIG. 1 is a partial schematic and cutaway view of the preferred embodiment showing the invention.

FIG. 2 is a partial schematic and cutaway view of the preferred embodiment showing the invention with an optional mixing chamber.

FIG. 3 is a partial schematic and cutaway view of the preferred embodiment showing the invention having a chamfered stinger end.

FIG. 4 is a cutaway view of an alternate of the preferred embodiment showing a duplication of the mixing container.

FIG. 5 is a partial schematic and cutaway view of an alternate of the preferred embodiment showing a an optional diffuser plate adjacent the stinger end.

### DESCRIPTION OF THE PREFERRED EMBODIMENTS

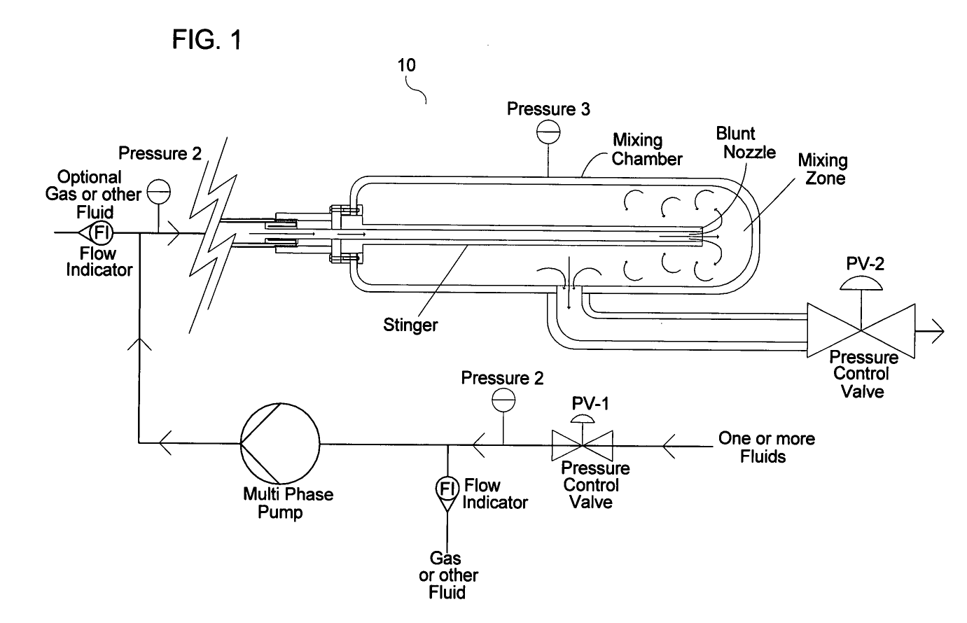

An apparatus generally referred to as 10 for mixing and or blending fluids, using the apparatus as shown in FIG. 1.

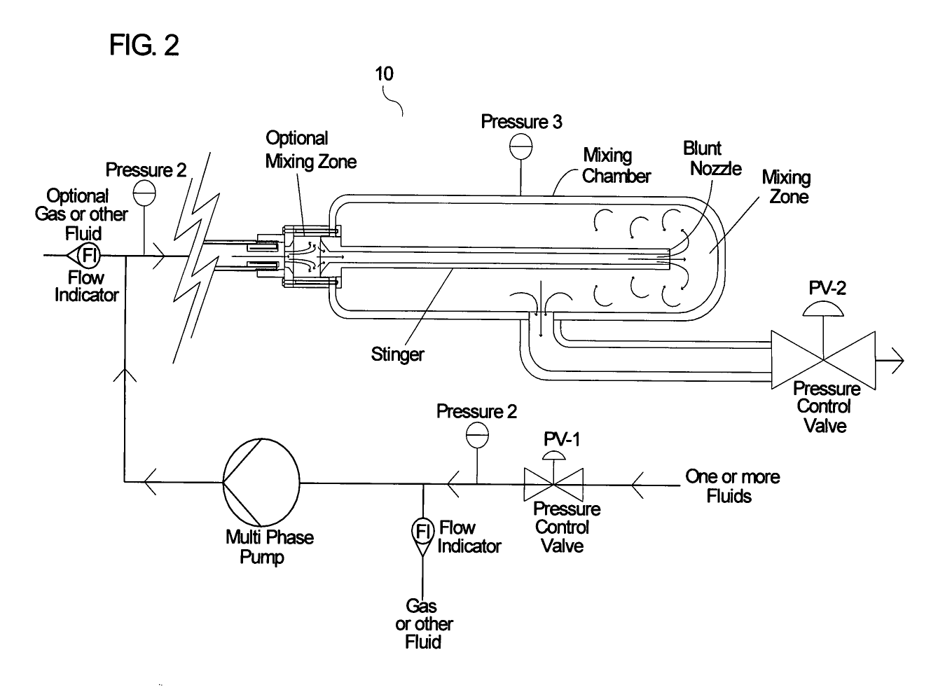

As seen in FIG. 1, one or more primary fluids pass through valve PV-1 where the suction to the multi-phase pump is held at a fixed pressure below atmospheric pressure. Another stream of gas or gases and/or fluid or fluids are naturally aspirated into the primary stream from PV-1 at a controlled flow rate. If a gas is being aspirated into the primary stream, the flow rate would not exceed 20 percent by volume of the primary stream. The discharge pressure of the multi-phase pump will be maintained at a pressure ranging from 50 PSIG (pounds per square inch-gauge) to 150 PSIG and indicated at Pressure 2. This pressure will be controlled by valve PV-2. As an option, gas or gases and/or fluid or fluids can be injected into the primary stream instead of, or in conjunction with the aspirated stream at the suction of the multi-phase pump. The commingled fluids pass through the optional mixing chamber as seen in FIG. 2 where a slight pressure drop creates turbulence for the mixing process. An additional pressure drop is realized in the main mixing zone (see Pressure 3) where turbulence is created in the mixing container. The pressure in the mixing container will be from, 60-90 percent of the pressure at Pressure 2. This pressure differential provides the energy for the mixing and blending action. The pressures at Pressure 2 and Pressure 3 will determine the degree of mixing and/or bubble size downstream of PV-2.

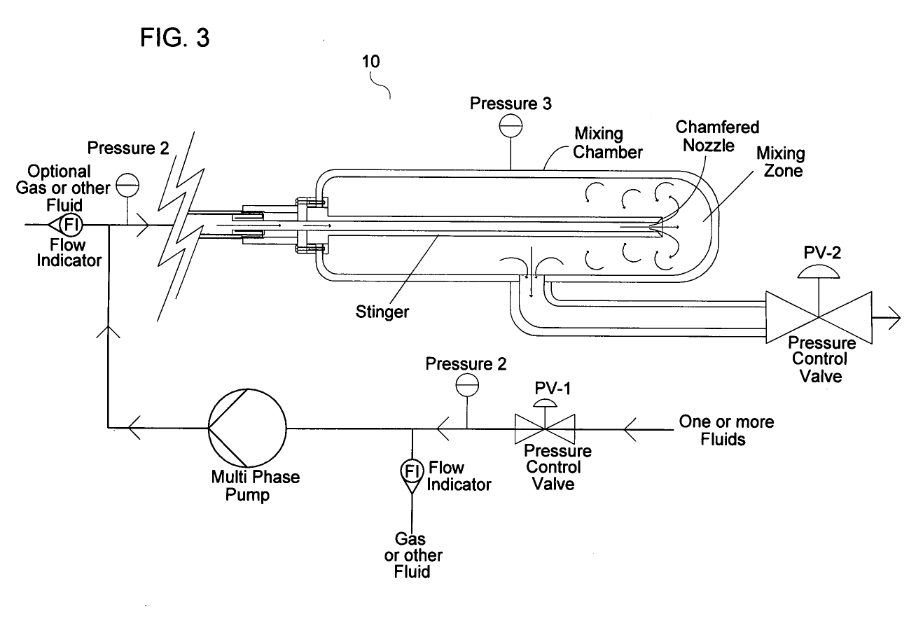

As seen in FIG. 3 the stinger end is chamfered on the inside edge. This chamfer reduces the shearing effect of the normally used blunt end of the stinger as shown in FIGS. 1 and 2, which is desirable in mixing/blending of certain fluids.

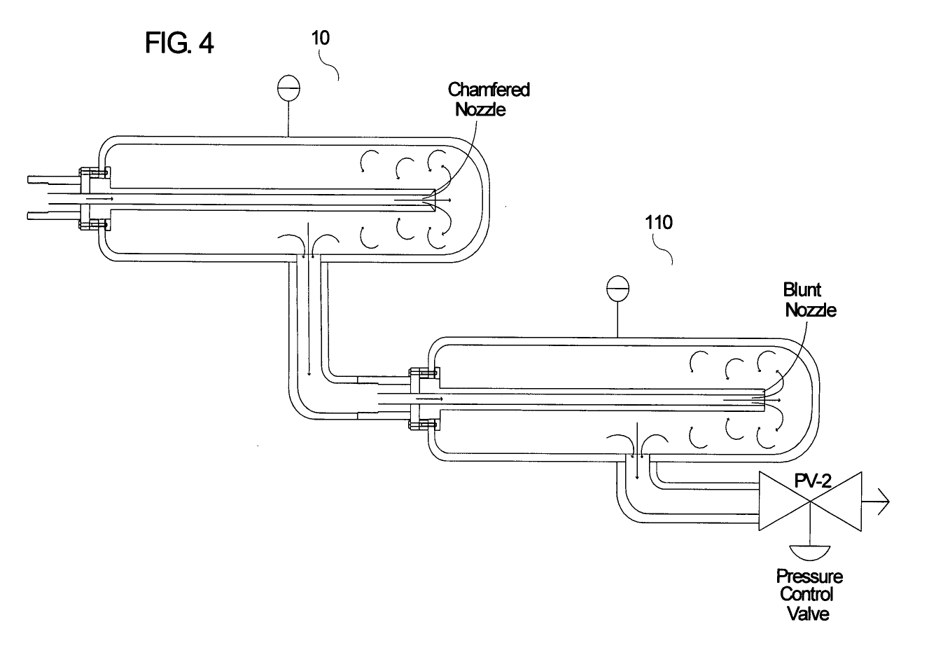

As seen in FIG. 4 a second mixing apparatus 110 including a stinger is duplicated downstream of primary mixing apparatus 10. In this example the first container's stinger end has the same inside chamfer as shown in FIG. 3. The second downstream mixing container includes a stinger end that is blunt as shown in FIGS. 1 and 2. This can be changed to have both stingers chamfered or both stingers ends blunt, or the first stinger end blunt or the second stinger end chamfered depending on which is most desirable in mixing/blending of certain fluids.

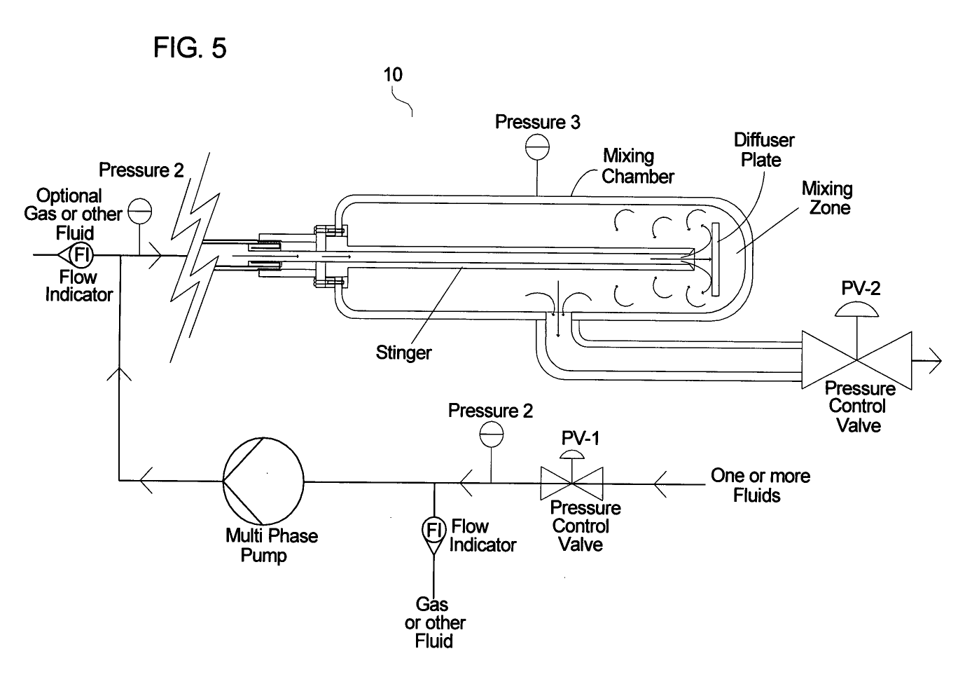

As seen in FIG. 5 an optional diffuser plate is mounted adjacent the end of the stinger nozzle. The diffuser nozzle will assist in mixing and/or blending of some fluids.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

It is intended that the scope of the invention be defined by the Claims appended hereto and their equivalents.

1. An apparatus for mixing and/or blending fluids comprising:
a pressurized cylindrical container having an inlet and an outlet;
said inlet attaching at least one elongated cylindrical tube having a fixed internal diameter;
where said elongated cylindrical tube is approximately centered therein said container;
where at least one first fluid and at least one second fluid enter said elongated cylindrical tube;
where said elongated cylindrical tube extends therein said cylindrical container between 2 percent to 80 percent the length of said container;
said elongated cylindrical tube having a squared off blunt end;
where said squared off blunt end causes said at least one first fluid to substantially commingle with said at least one second fluid inside said cylindrical container when exiting said elongated cylindrical tube at said squared off blunt end;
where said at least one first fluid and said at least one second fluid is pressurized within said cylindrical container; and
where said pressure of said fluids within said cylindrical container is between 50 percent to 90 percent of pressure of said fluids within inlet of said elongated cylindrical tube, thus substantially mixing and/or blending said at least one first fluid and said at least one second fluid before exiting said cylindrical container through said outlet.

2. An apparatus for mixing and/or blending fluids as defined in claim 1, where said squared off blunt ended elongated cylindrical tube has an inward chamfered end.

3. An apparatus for mixing and/or blending fluids as defined in claim 1, where said outlet pressure is controlled by a valve attached to said outlet outside of said cylindrical container.

4. An apparatus for mixing and/or blending fluids as defined in claim 1, where said elongated cylindrical tube end includes a diffuser plate directly adjacent said tube end.

5. An apparatus for mixing and/or blending fluids as defined in claim 1, where there are at least three said elongated cylindrical tubes approximately centered at said inlet inside said cylindrical container.

6. An apparatus for mixing and/or blending fluids as defined in claim 1, where said elongated cylindrical tube end has an inwardly chamfer and includes a diffuser plate directly adjacent said tube end.

7. An apparatus for mixing and/or blending fluids as defined in claim 1, where said pressurized cylindrical container inlet includes a primary mixing zone therein said inlet.

8. A method for mixing and/or blending fluids comprising steps of:
streaming at least one first fluid and at least one second fluid into a pressurized cylindrical container having an inlet and an outlet;
streaming said at least one first fluid and said at least one second fluid inlet through at least one elongated cylindrical having a fixed internal diameter;
substantially centering said elongated cylindrical tube therein said container;
where at least one first fluid and at least one second fluid enter said elongated cylindrical tube;
extending said elongated cylindrical tube therein said cylindrical container between 2 percent to 80 percent the length of said container;
streaming at least one first fluid and at least one second fluid past a squared off blunt end on said elongated cylindrical tube;
substantially commingling said at least one first fluid with said at least one second fluid inside said cylindrical container; and
pressurizing said at least one first fluid and at said least one second fluid within said cylindrical container between a pressure of 50 percent to 90 percent of said fluids at the inlet of said elongated cylindrical tube, thus substantially mixing and/or blending said at least one first fluid and said at least one second fluid as said at least one first fluid and said at least one second fluid exit said cylindrical container through said outlet.

9. A method for mixing and/or blending fluids as defined in claim 6, where said squared off blunt ended elongated cylindrical tube has an inward chamfered end.

10. A method for mixing and/or blending fluids as defined in claim 6, where said container pressure is controlled by a valve attached to said outlet outside of said cylindrical container.

11. A method for mixing and/or blending fluids as defined in claim 6, where said elongated cylindrical tube end includes a diffuser plate directly adjacent said tube end.

12. A method for mixing and/or blending fluids as defined in claim 6, where there are at least three said elongated cylindrical tubes approximately centered at said inlet inside said cylindrical container.

13. A method for mixing and/or blending fluids as defined in claim 6, where said elongated cylindrical tube end has an inwardly chamfer and includes a diffuser plate directly adjacent said tube end.

14. A method for mixing and/or blending fluids as defined in claim 6, where said pressurized cylindrical container inlet includes a primary mixing zone therein said inlet.
